(19) United States
(12) Patent Application Publication
(10) Pub. No.: US 2019/0013610 A1
(43) Pub. Date: Jan. 10, 2019

(54) MULTI-CONTACT CONNECTOR

(71) Applicant: IRISO ELECTRONICS CO., LTD., Yokohama-shi (JP)

(72) Inventors: Hitoshi SUZUKI, Yokohama-shi (JP); Hiroaki KOBAYASHI, Yokohama-shi (JP); Yoshiyuki OGURA, Yokohama-shi (JP); Tomomitsu SAITO, Yokohama-shi (JP); Daichi SHIMBA, Yokohama-shi (JP); Koji KUNIYOSHI, Yokohama-shi (JP)

(73) Assignee: IRISO ELECTRONICS CO., LTD., Yokohama-shi (JP)

(21) Appl. No.: 16/001,108

(22) Filed: Jun. 6, 2018

(30) Foreign Application Priority Data
Jun. 6, 2017 (JP) 2017-111380

(51) Int. Cl. H01R 13/24

(52) U.S. Cl. CPC H01R 13/2457

(57) ABSTRACT

A multi-contact connector includes terminals, which each include a first contact piece section, which has a first contact section, which achieves pressing contact with a pin terminal in a first direction, and a first elastic arm, which extends in a direction that intersects the first direction and displaceably supports the first contact section, and a second contact piece section, which has a second contact section, which achieves pressing contact with the pin terminal in the first direction, and a second elastic arm, which displaceably supports the second contact section. The second elastic arm extends in the first direction, which intersects the direction in which the first elastic arm extends, and an end portion of the second elastic arm or the end portion in the extending direction, that is, the front end facing the first elastic arm is formed as a spring piece linked to the second contact section.

### BACKGROUND OF THE INVENTION

### Field of the Invention

The present invention relates to a multi-contact connector having a plurality of contacts that come into contact with a connection target object.

### Description of the Related Art

As a connector that achieves electrically continuous connection between a circuit in a substrate and a connection target object with high connection reliability, there is a known multi-contact connector having a plurality of contacts that achieve electrically continuous connection with a connection target object (Japanese Patent Laid-Open No. 2012-221592 and FIG. 9 of Japanese Patent Laid-Open No. 2015-5504). In the case of a multi-contact connector, even if one of the contacts that are in contact with the connection target object fails to achieve electrical continuity, the other contact still achieves electrically continuous contact, whereby the electrically continuous connection that the connector should achieve can maintained. In particular, in a case where foreign matter, such as substrate residues and dust, adheres to a counterpart terminal, an FPC, or any other flat conductor, which is the connection target object, the foreign matter sandwiched between any of the contacts and the connection target object is likely to cause electrical continuity failure, and a multi-contact connector having a plurality of contacts is therefore believed to be useful.

Considering the arrangement of the plurality of contacts of each of the terminals of a multi-contact connector, the plurality of contacts are so disposed as to be positionally shifted along the insertion direction of the connection target object. For example, in the multi-contact connector described in Japanese Patent Laid-Open No. 2015-5504, each terminal includes a base section fixed to a housing and a front terminal and a rear terminal that extend from the base section. The front terminal is formed of two front spring sections that extend from the base section in parallel to each other in the form of a cantilever and a front contact that links the front ends of the two front spring sections to each other and achieves electrically continuous contact with a connection target object. On the other hand, the rear terminal is formed of one rear spring section that is disposed between the two front spring sections and extends from the base section in the form of a cantilever and a rear contact provided at the front end of the rear spring section. Many multi-contact connectors employ the terminal structure described above (see FIG. 1 of Japanese Utility Model Laid-Open No. 48-30755, FIGS. 1 to 3 of Japanese Patent Laid-Open No. 2004-152623, FIGS. 3 and 4 of Japanese Utility Model Laid-Open No. 58-7477).

The multi-contact connectors of related art described above, however, have a problem of an increase in the length of each of the terminals and hence an increase in the size of the multi-contact connector itself. That is, the front terminal and the rear terminal, which extend from the base section, need to be so configured that the front spring sections and the rear spring section are each long enough for elasticity as a spring. Further, since the front contact and the rear contact need to be provided at the front ends of the front spring sections and the rear spring section, the length of the terminal undesirably increases along the insertion direction of the connection target object.

The present invention has been made based on the related art described above. An object of the present invention is to provide a multi-contact connector that allows the terminals to be shortened. Another object of the present invention is to reduce the size of the multi-contact connector based on the shortened terminals.

### SUMMARY OF THE INVENTION

To achieve the objects described above, the present invention has the following features:

That is, the present invention relates to a multi-contact connector including terminals each including a first contact piece section having a first contact section that achieves pressing contact with a connection target object in a first direction and a first elastic arm that extends in a direction that intersects the first direction and displaceably supports the first contact section, and a second contact piece section having a second contact section that achieves pressing contact with the connection target object in the first direction and a second elastic arm that displaceably supports the second contact section, and the second elastic arm extends in the first direction toward the first elastic arm and has a front end portion that faces the first elastic arm and is formed as a spring piece linked to the second contact section.

According to the present invention, the second elastic arm extends in the first direction, which intersects the direction in which the first elastic arm extends, and an end portion of the second elastic arm or the end portion in the extending direction, that is, the front end facing the first elastic arm is formed as a spring piece linked to the second contact section. It is therefore unnecessary to employ the terminal structure of related art in which the first elastic arm and the second elastic arm extend from the same portion of the terminal in parallel to each other, and the novel terminal structure in which the second elastic arm extends toward the first elastic arm allows reduction in the total length of the terminal as compared with the total length of each terminal of the multi-contact connector of related art, whereby the multi-contact connector, which includes the terminals, can be so formed as to be compact.

The second contact section can be configured to face the first elastic arm.

According to the present invention, since the second contact section faces the first elastic arm, the size of the terminal structure can be reduced. In a case where the second contact section is a flat-plate-shaped contact piece, the second contact section can be so disposed that the plate surface of the second contact section and the plate surface of the first elastic arm face each other. As a result, since the plate surfaces face each other and extend in parallel to each other, the size of the terminal structure can be reduced.

The terminals can each be configured to have a support piece to which the second elastic arm is linked.

According to the present invention, since the support piece to which the second elastic arm is linked is provided, the second elastic arm can be configured as a cantilever-shaped spring piece supported by the support piece and extending in the first direction.

The support piece can be so formed as to extend from a portion linked to the second elastic arm to a position facing the second contact section.

According to the present invention, the support piece, which is so shaped as to face the second contact section, can accept the connection target object that receives the pressing contact achieved by the second contact section. Therefore, as compared with a case where the connection target object is accepted by a resin housing of a multi-contact connector, the tolerance of the distance between the second contact section and a connection target object receiving surface can be managed based only on the tolerance of the terminal, whereby the connection target object can be appropriately held irrespective of the precision of molding of the resin housing and the precision of assembly thereof. Further, the support piece can be shortened as compared with a case that will be described later where the support piece is so formed as to extend to the position facing both the first contact section and the second contact section, and the size of the entire terminal can also be reduced.

The support piece can be so formed as to extend from a portion linked to the second elastic arm to a position facing the first contact section and the second contact section.

According to the present invention, the support piece, which is so shaped as to face the first contact section and the second contact section, can accept the connection target object that receives the pressing contact achieved by the first contact section and the second contact section. Therefore, as compared with the case where the connection target object is accepted by a resin housing of a multi-contact connector, the tolerance of the distances from the first and second contact sections to the connection target object receiving surface can be managed based only on the tolerance of the terminal, whereby the connection target object can be appropriately held irrespective of the precision of molding of the resin housing and the precision of assembly thereof.

The second elastic arm can be so shaped as to link opposing plate edges of the second contact section and the support piece.

According to the present invention, the second contact section achieves pressing contact with the connection target object in the first direction, in which the first contact section achieves pressing contact with the connection target object, but the second elastic arm, which supports the second contact section, extends from one of the plate edges of the support piece, which faces the first contact piece section, whereby the size of the second contact piece section can be reduced. Therefore, the size of the contact section, which has a terminal structure having the two contact piece sections, can be reduced, and the size of the multi-contact connector can also be reduced.

The terminals can each be configured to have a fixed base section that supports the first contact piece section in a form of a cantilever and a linkage section that extends in the first direction and links the fixed base section to the support piece.

According to the present invention, since the terminals each have the fixed base section, which supports the first contact piece section in the form of a cantilever, and the linkage section, which extends in the first direction and links the fixed base section to the support piece, the fixed base section and the support piece can be integrated with each other via the linkage section.

The first contact piece section can be configured to have a clearance recess section that avoids contact with the second contact section displaced toward the first contact piece section when the second contact section receives the pressing contact achieved by the connection target object.

According to the present invention, the first contact piece section has the clearance recess section. The second contact section, when it is displaced by the pressing contact produced by the connection target object, therefore does not come into contact with first contact piece section. The first contact piece section and the second contact section can therefore be so disposed as to approach each other, as compared with a case where the first contact piece section is provided with no clearance recess section, whereby the entire size of the contact section can be reduced, and the size of the multi-contact connector can also be reduced.

According to the present invention, the terminal structure in which the first contact section and the second contact section, which achieve electrically continuous contact with the connection target object, are provided and the second elastic arm extends toward the first elastic arm allows the total length of each of the terminals to be shortened, whereby a compact multi-contact connector having high connection reliability can be provided.

### BRIEF DESCRIPTION OF THE DRAWINGS

FIG. 1 is an exterior perspective view including the front surface, the right side surface, and the plan surface of a multi-contact connector according to a first embodiment;

FIG. 2 is a front view of the multi-contact connector shown in FIG. 1;

FIG. 3 is a bottom view of the multi-contact connector shown in FIG. 1;

FIG. 4 is an exterior perspective view including the front surface, the right side surface, and the plan surface of a movable housing provided in the multi-contact connector shown in FIG. 1;

FIG. 5 is a plan view of the movable housing shown in FIG. 3;

FIG. 6 is an exterior perspective view including the front surface, the right side surface, and the plan surface of a terminal provided in the multi-contact connector shown in FIG. 1;

FIG. 7 is an exterior perspective view including the rear surface, the left side surface, and the plan surface of the terminal shown in FIG. 6;

FIG. 8 is a left side view of the terminal shown in FIG. 6;

FIG. 9 is a cross-sectional view taken along the line IX-IX in FIG. 2;

FIG. 10 describes the action of the terminal shown in FIG. 6;

FIG. 11 is an exterior perspective view including the front surface, the right side surface, and the plan surface of a terminal provided in a multi-contact connector according to a second embodiment;

FIG. 12 is a left side view of the terminal shown in FIG. 11;

FIG. 13 is a left side view of a terminal provided in a multi-contact connector according to a third embodiment;

FIG. 14 is an enlarged view of a contact section of the terminal shown in FIG. 13;

FIGS. 15A and 15B describe the action of the terminal shown in FIG. 13, FIG. 15A describing the action of the terminal in the second embodiment described with reference to FIG. 11, and FIG. 15B describing the action of the terminal in the third embodiment described with reference to FIG. 13; and

FIG. 16 is an enlarged view of a contact section according to a variation of the terminal shown in FIG. 13.

### DETAILED DESCRIPTION OF THE PREFERRED EMBODIMENTS

Embodiments of a multi-contact connector according to the present invention will be described below with reference to the drawings. In the scope of the present specification and claims, the width direction or the rightward/leftward direction of the multi-contact connector is a direction X, the depth direction or the frontward/rearward direction thereof is a direction Y, and the height direction or the upward/downward direction thereof is a direction Z for ease of description, but the definition of the directions is not intended to limit a method for mounting the multi-contact connector or a method for using the multi-contact connector.

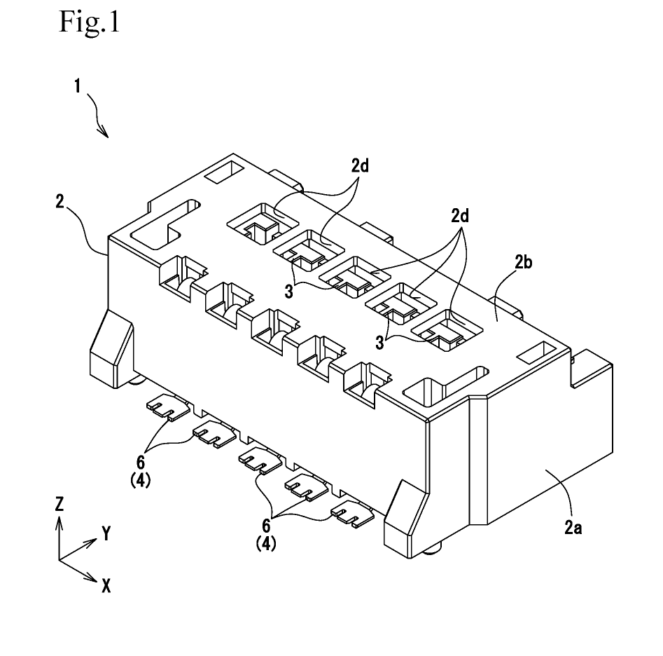

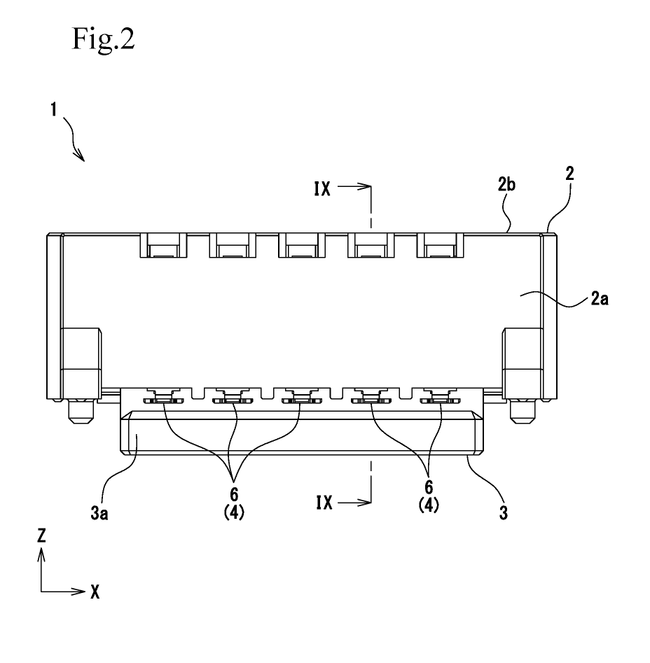

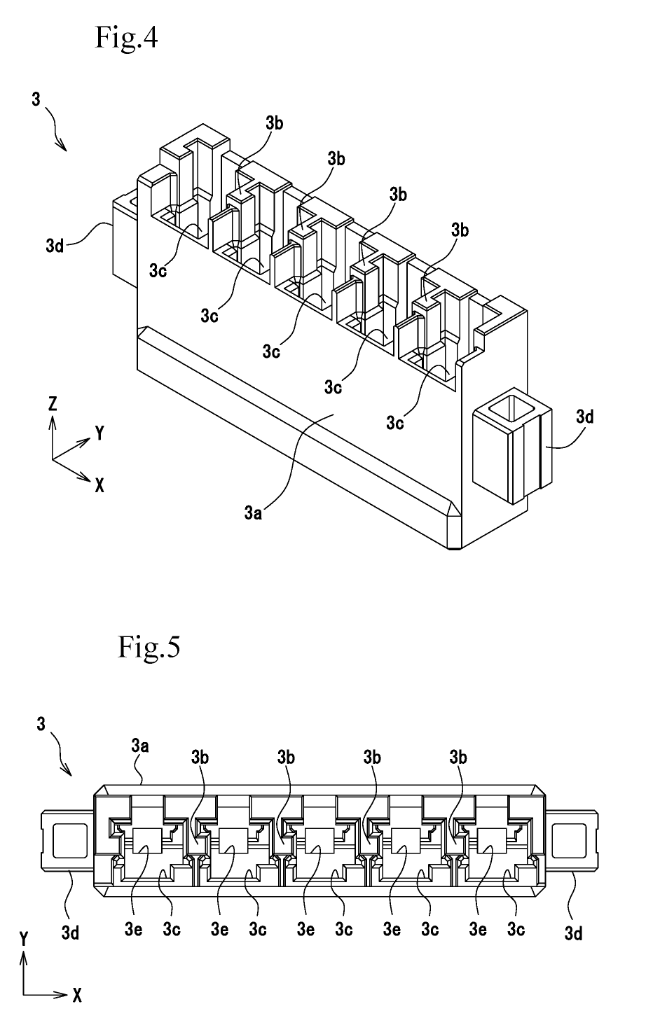

### First Embodiment [FIGS. 1 to 10]

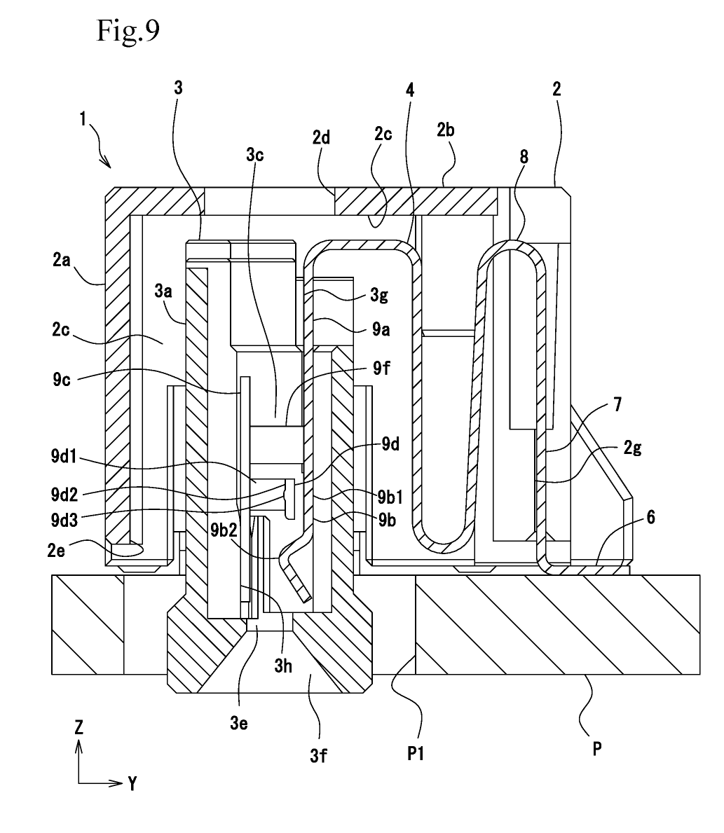

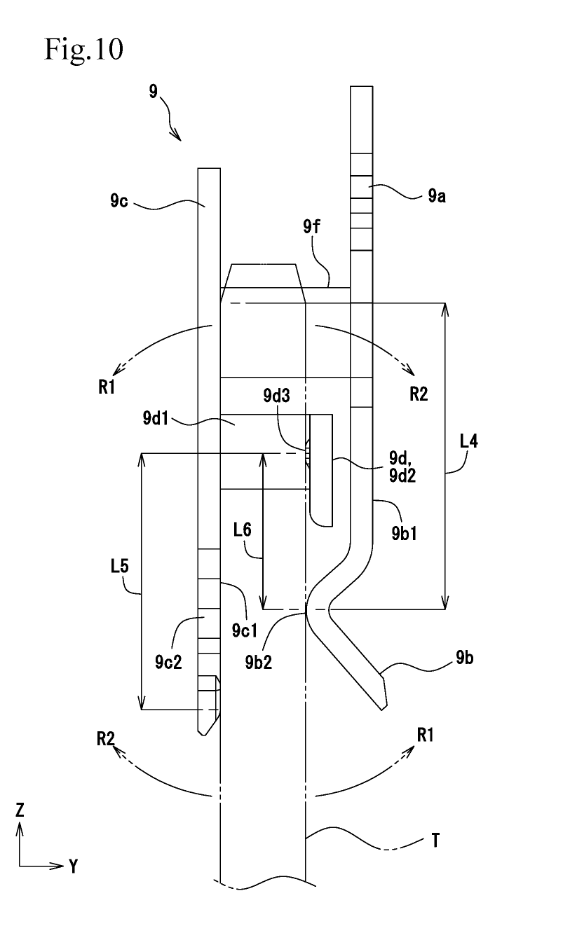

A multi-contact connector 1 includes a fixed housing 2 as a “first housing,” a movable housing 3 as a “second housing,” a plurality of terminals 4, and a plurality of fixtures 5, which fix the fixed housing 2 to a substrate P. The multi-contact connector 1 is configured as a movable connector in which the plurality of terminals 4 support the movable housing 3 in such a way that the movable housing 3 is displaceable relative to the fixed housing 2. The multi-contact connector 1 is configured as a bottom-entry connector which is mounted on one surface of the substrate P and into which pin terminals T as the “connection target object” are inserted via the other surface of the substrate P for electrically continuous connection (FIGS. 9 and 10).

### [Fixed Housing 2]

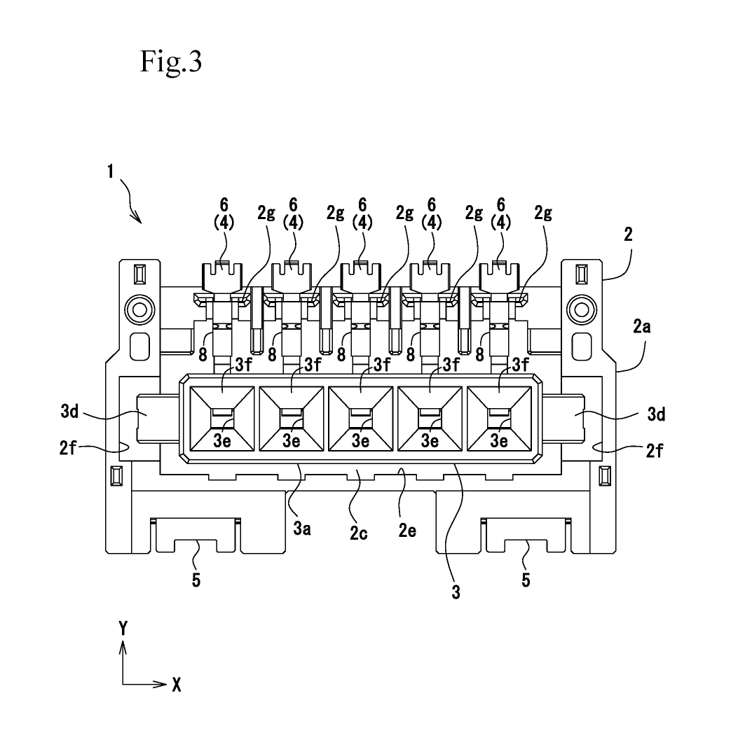

The fixed housing 2 is formed of a resin molded body and has an outer circumferential wall 2a and a top wall 2b. The outer circumferential wall 2a is formed in a rectangular tubular shape, and an accommodation chamber 2c, which accommodates the movable housing 3, is formed inside the outer circumferential wall 2a and the top wall 2b (FIGS. 3 and 9). The movable housing 3 is so held by the plurality of terminals 4 as to be displaceable in three-dimensional directions in the in-chamber space of the accommodation chamber 2c. The fixtures 5 described above are press-fitted and fixed to the rear surface of the outer circumferential wall 2a of the fixed housing 2 and in opposite positions in the width direction X (FIG. 3). A plurality of top openings 2d, which allow visual recognition of the state of connection between the pin terminals T and the terminals 4, are formed in the top wall 2b of the fixed housing 2 (FIGS. 1 and 9). In the present embodiment, five top openings 2d are arranged in a single row along the width direction X. The top openings 2d also function as heat dissipating windows for dissipating heat generated in the pin terminals T and the terminals 4 when current flows therethrough out of the fixed housing 2. A bottom opening 2e is formed in the bottom surface of the fixed housing 2, and the movable housing 3 is inserted through the bottom opening 2e into the accommodation chamber 2c.

### [Movable Housing 3]

The movable housing 3 is formed of a resin molded body so sized in the width direction X and the depth direction Y as to be accommodated in the accommodation chamber 2c of the fixed housing 2 and has an outer circumferential wall 3a and a plurality of partition walls 3b, which divide the interior of the outer circumferential wall 3a into a plurality of spaces. The outer circumferential wall 3a is formed in a rectangular tubular shape, and inner spaces surrounded by the outer circumferential wall 3a and the partition walls 3b are configured as a plurality of connection chambers 3c, where the terminals 4 achieve electrically continuous connection with the pin terminals T. In the present embodiment, five connection chambers 3c are arranged in a single row along the width direction X. Contact sections 9 of the terminals 4, which will be described later, are fixed in the connection chambers 3c. Displacement restricting protrusions 3d are so formed as to protrude from the opposite side surface, in the width direction X, of the outer circumferential wall 3a. The displacement restricting protrusions 3d are so disposed as to protrude into displacement restricting recesses 2f, which are formed on both sides, in the width direction X, of the accommodation chamber 2c of the fixed housing 2 described above (FIG. 3). The movable housing 3 is displaceable until the displacement restricting protrusions 3d abut against the displacement restricting recesses 2f in the rightward/leftward direction X, the frontward/rearward direction Y, and the height direction Z (only upward). The downward displacement in the height direction Z is restricted when the displacement restricting protrusions 3d abut against the substrate P. A lower end portion of the movable housing 3 has been inserted through a through hole P1 of the substrate P and protrudes beyond the rear surface of the substrate P (FIG. 9). Insertion ports 3e, through which the pin terminals T are inserted, are formed in the bottom surface of the movable housing 3. The insertion ports 3e each have a funnel-shaped guiding inclining surface 3f, and the pin terminals T are guided along the guiding inclining surfaces 3f and inserted via the insertion ports 3e into connection chambers 3c.

### [Terminals 4]

The terminals 4 each include a substrate fixing section 6, a fixed housing fixing section 7, which is press-fitted and fixed to the fixed housing 2, a movable section 8, which supports the movable housing 3 in such a way that the movable housing 3 is displaceable relative to the fixed housing 2, and a contact section 9, which is accommodated in the corresponding connection chamber 3c of the movable housing 3 and achieves electrically continuous connection with the corresponding pin terminal T. The functional portions and the shape of each of the terminals 4 are achieved and formed by bending a punched electrically conductive metal piece and integrated with one another. That is, the terminals 4 are each formed as a single part.

The substrate connecting section 6 protrudes frontward beyond the front surface of the fixed housing 2 and is soldered to the substrate P. The fixed housing 2 is fixed by the substrate connecting sections 6 on the front side of the fixed housing 2 and fixed by the fixtures 5 in a soldering process on the rear side of the fixed housing 2, whereby the fixed housing 2 can reliably accept the force produced when the plurality of pin terminals T are inserted via the rear surface of the substrate P.

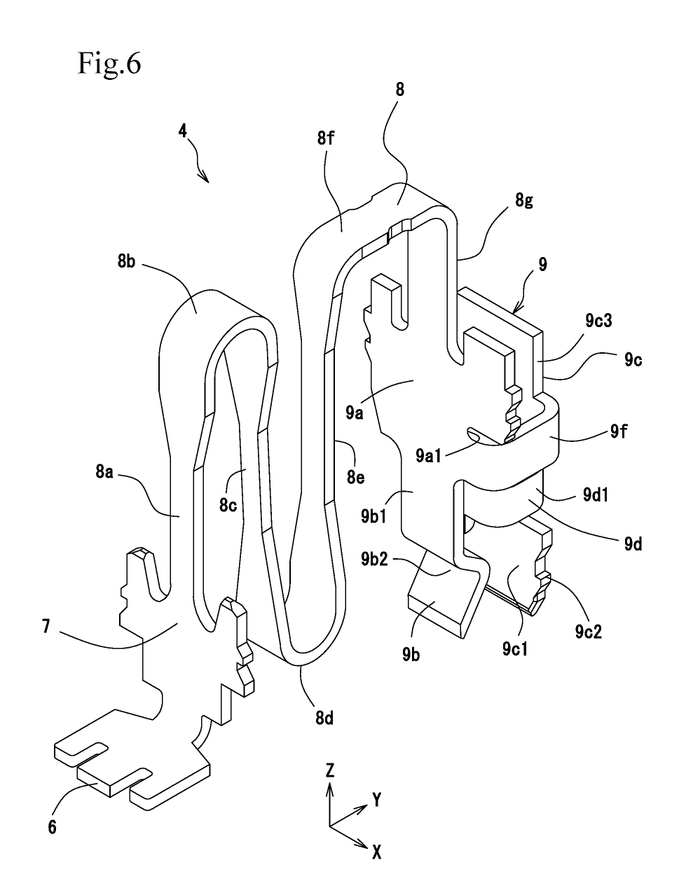

The fixed housing fixing section 7 is press-fitted and fixed to the corresponding one of terminal fixing grooves 2g, which are provided in the accommodation chamber 2c of the fixed housing 2 (FIGS. 3 and 9). The movable section 8 has a first extending section 8a, which extends upward from the fixed housing fixing section 7, a first bent section 8b, which is folded back at the upper end of the first extending section 8a, a second extending section 8c, which extends from the first bent section 8b in parallel to the first extending section 8a, a second bent section 8d, which is folded back at the lower end of the second extending section 8c, a third extending section 8e, which extends from the second bent section 8d in parallel to the second extending section 8c, a third bent section 8f, which is folded back at the upper end of the third extending section 8e, and a fourth extending section 8g, which is linked to a fixed base section 9a, which will be described later, as shown in FIGS. 6 to 8. The first extending section 8a, the second extending section 8c, and the third extending section 8e are so each formed that the plate width thereof along the direction X gradually decreases with distance from the side where the extending section is linked to the first bent section 8b, the second bent section 8d, or the third bent section 8f, whereby the extending section can achieve softness as a spring. Further, the movable section 8 has a long spring length because three longitudinal spring pieces (first extending section 8a, second extending section 8c, and third extending section 8e) that extend in the upward/downward direction (direction Z) are arranged in parallel to one another. The third extending section 8e may be omitted if the movable section 8 only needs to be displaceable in the frontward/rearward direction Y. However, the three longitudinal spring pieces disposed in parallel to one another as described above not only allow the movable housing 3, which is particularly displaced in the frontward/rearward direction Y, to be so elastically supported that the movable housing 3 can be flexibly displaced but increase durability as a spring.

The contact section 9 has a fixed base section 9a, which is linked to the fourth extending section 8g of the movable section 8 and fixed to the movable housing 3, a first contact piece section 9b, which extends from the fixed base section 9a in the form of a cantilever, a contact receiving section 9c, which faces the first contact piece section 9b as a “support piece”, a second contact piece section 9d, which extends from the contact receiving section 9c in the form of a cantilever, and a linkage section 9f, which links the fixed base section 9a to the contact receiving section 9c, as shown in FIGS. 6 to 8.

The fixed base section 9a is press-fitted fixed to the corresponding one of first terminal fixing grooves 3g, which are provided in the movable housing 3, as shown in FIG. 9.

The first contact piece section 9b has a first elastic arm 9b1, which extends from the fixed base section 9a, and a first contact section 9b2, which is displaceably supported by the first elastic arm 9b1 and achieves pressing contact with the corresponding pin terminal T, which is the connection target object, in a “first direction,” that is, from the front side toward the rear side in the frontward/rearward direction Y. The first contact section 9b2 is so formed as to protrude in a convexly bent shape toward the contact receiving section 9c.

The contact receiving section 9c, which forms the “support piece” of the present invention, is formed, as a whole, as a flat-plate-shaped metal piece, and a surface of the contact receiving section 9c facing the first contact piece section 9b is formed as a flat contact surface section 9c1, which extends along the insertion direction of the pin terminals T (direction Z). The contact surface section 9c1, which is a portion that comes into contact with the corresponding pin terminal T, is so formed as to be longer than at least the inter-contact distance between the first contact section 9b2 and a second contact section 9d2 (contact 9d3). The contact receiving section 9c, which is so shaped as to face both the first contact section 9b2 and the second contact section 9d2, can accept the pin terminal T that receives pressing contact achieved by both the first contact section 9b2 and the second contact section 9d2. Therefore, as compared with a case where the pin terminal T is accepted, for example, by the resin wall of the connection chamber 3c of the movable housing 3, the tolerance of the distances from the first contact section 9b2 and the second contact section 9d2 to the contact receiving section 9c, which serves as the surface that receives the pin terminal T, can be managed based only on the tolerance of the terminal 4, whereby the pin terminal T can be appropriately held at predetermined contact pressure irrespective of the precision of molding of the movable housing 3, which is formed of a molded body, and the precision of assembly of the terminal 4 to the movable housing 3. An end portion of the contact receiving section 9c facing the first contact section 9b2 has fixing sections 9c2, which are press-fitted and fixed to the corresponding one of second terminal fixing grooves 3h of the movable housing 3, as shown in FIG. 9. The contact receiving section 9c itself is therefore press-fitted and fixed to the movable housing 3 independently of the other sections of the contact section 9. The contact surface section 9c1 is so disposed as to be exposed to the corresponding connection chamber 3c of the movable housing 3 except the fixing sections 9c2, which are press-fitted and fixed to the second terminal fixing groove 3h. The reason for this is that the contact surface section 9c1 receives sliding contact provided by the pin terminal T inserted into the connection chamber 3c and achieves electrically continuous connection with the pin terminal T in the fitting state. A surface of the contact receiving section 9c which is opposite the contact surface section 9c1 is in contact with the resin wall of the movable housing 3, and the pressing force received from the pin terminal T is accepted by the resin wall via the contact receiving section 9c.

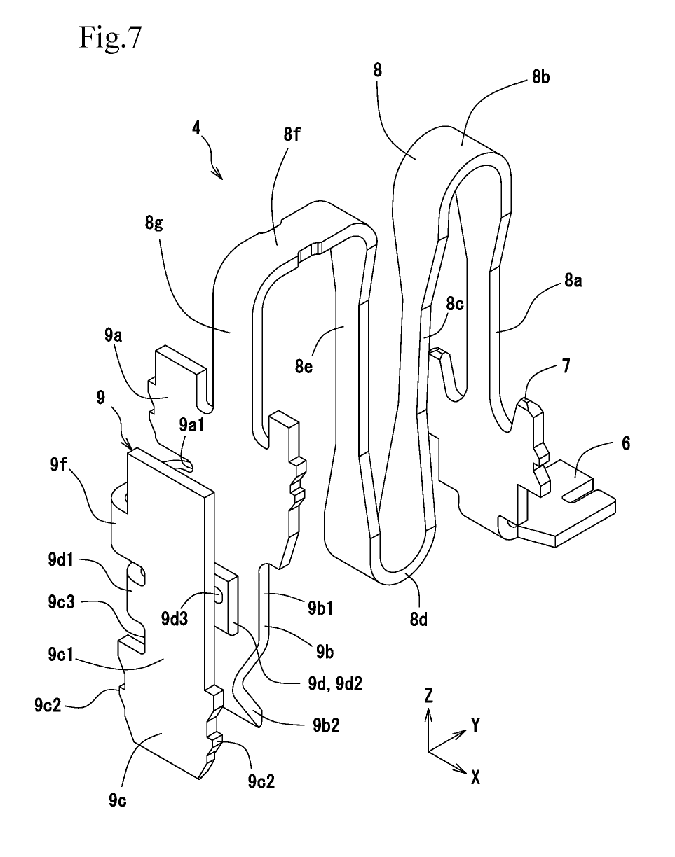

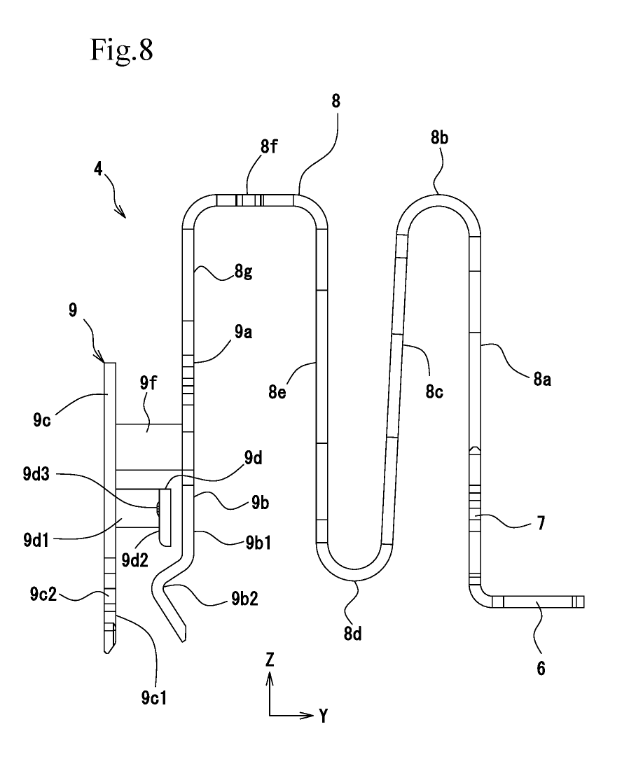

The second contact piece section 9d has a second elastic arm 9d1 and the second contact section 9d2, as shown in FIGS. 8 and 10. The second elastic arm 9d1 has a base end linked to one of plate edges 9c3 (right plate edge) of the contact receiving section 9c (FIGS. 6 and 7), bends from the plate edge 9c3, and extends toward the first contact piece section 9b. More specifically, the front end of the second elastic arm 9d1 extends to a position above the first contact section 9b2, which has a convexly bent shape, and adjacent to the first elastic arm 9b1, as shown in FIG. 8, and the front end is linked to the second contact section 9d2, which is formed of a plate piece parallel to the plate surface of the first elastic arm 9b1, via a bent portion. Therefore, the second contact section 9d2, seen from the insertion direction Z of the pin terminals T, is so disposed as to be hidden behind the first contact section 9b2, which has a convexly bent shape. The second contact section 9d2 is formed in a plate-like shape, and a surface of the second contact section 9d2 facing the contact receiving section 9c has the contact 9d3, which achieves pressing contact with the pin terminal T.

The linkage section 9f has one end linked to one of plate edges 9a1 (right plate edge) of the fixed base section 9a (FIGS. 6 and 7) and the other end formed as a spring piece linked to the right plate edge 9c3 of the contact receiving section 9c. The linkage section 9f and the second elastic arm 9d1 are therefore disposed side by side in the direction Z. The contact receiving section 9c is fixed to the movable housing 3 via the fixing sections 9c2 on the front end side (lower end side), and the contact receiving section 9c is further fixed to the movable housing 3 via the linkage section 9f and the fixed base section 9a on the opposite side (upper end side) because the other end of the linkage section 9f is linked to the contact receiving section 9c. Therefore, the contact receiving section 9c is reliably fixed to the movable housing 3 and can accept the contact provided by the pin terminal T when the contact receiving section 9c is in contact with the pin terminal T along the length thereof.

### [Advantageous Effects of Multi-Contact Connector 1]

Advantageous effects of the thus configured multi-contact connector 1 will next be described.

The multi-contact connector 1 is so configured that the movable housing 3 is so supported by the movable sections 8 of the terminals 4 as to be displaceable relative to the fixed housing 2 in the three-dimensional directions (direction X, direction Y, direction Z, and combination thereof). Therefore, in the fitting connection of the pin terminals T, a shift in the insertion position of the pin terminals T can be absorbed by displacement of the movable housing 3 for adequate fitting connection. In the fitting connection state in which the pin terminals T are located in the proper contact position and achieve electrically continuous connection, when the pin terminals T or the substrate P is displaced due to vibration or impact, the vibration or any other external factor can be absorbed by displacement of the movable housing 3. Further, in the fitting connection state, both the first contact section 9b2 and the second contact section 9d2 achieve electrically continuous contact with a pin terminal T wile pressing the pin terminal T. Therefore, even if one of the contact sections fails to achieve the electrically continuous contact, the other contact section maintains the electrically continuous contact, whereby highly reliable electrically continuous connection can be achieved.

In addition to the basic advantageous effect described above, the multi-contact connector 1 has the following features: The second elastic arm 9d1 extends in the first direction (direction Y), which intersects the direction in which the first elastic arm 9b1 extends (direction Z), and an end portion in the extending direction of the second elastic arm 9d1, that is, the front end facing the first elastic arm 9b1 is formed as a spring piece linked to the second contact section 9d2. It is therefore unnecessary to employ the terminal structure of related art in which the first elastic arm 9b1 and the second elastic arm 9d1 extend from the same portion of the terminal 4 in parallel to each other, and the novel terminal structure in which the second elastic arm 9d1 extends toward the first elastic arm 9b1 allows reduction in the total length of the contact section 9 of the terminal 4 in the insertion direction of the pin terminals T (direction Z) as compared with the total length of the contact section of each terminal of the multi-contact connector of related art, whereby the multi-contact connector 1, which includes the terminals 4, can be so formed as to be compact.

A pin terminal T is so pressed by the first contact section 9b2 and the second contact section 9d2 as to come into contact therewith, and the pin terminal T comes into contact with the flat contact surface section 9c1 of the contact receiving section 9c in the pressing contact direction (direction Y). The contact surface section 9c1 has a flat surface shape that comes into contact with a pin terminal T along the length of the pin terminal T in accordance with the length of the inserted pin terminal T, resulting in no unstable electrically continuous contact with the pin terminal T. The multi-contact connector 1 can therefore more reliably suppress pivotal motion (inclination) of the pin terminal T at the first contact section 9b2 and the second contact section 9d2 (contact protrusion 9d3), which each serve as the center of the pivotal motion.

In the multi-contact connector 1, the pin terminal T, when it pivots in the counterclockwise direction R1, comes into contact with the first contact section 9b2 on the side close to the insertion port 3e of the connection chamber 3c, as shown in FIG. 10. On the other hand, on the far side in the connection chamber 3c, the insertion-side end portion of the pin terminal T comes into contact with the contact surface section 9c1. A long inter-contact distance L4 can thus be provided and reduce the effect of the pivotal motion of the pin terminal T in the counterclockwise direction R1, whereby even slight pivotal motion can be reliably handled. The pin terminal T tries to pivot around the point where the pin terminal T is in contact with the non-displacing contact surface section 9c1, but the pivotal motion is not allowed not only by the first contact piece section 9b but the second contact piece section 9d, which is located between the pin terminal T and the first contact piece section 9b. The two contact piece sections, the first contact piece section 9b and the second contact piece section 9d, can thus more reliably suppress the pivotal motion of the pin terminal T in the counterclockwise direction R1, whereby occurrence of plated film separation due to the minute sliding contact and other undesirably phenomena can be avoided.

Similarly, the pin terminal T, when it pivots in the clockwise direction R2, comes into contact with the second contact section 9d2 (contact protrusion 9d3) on the far side in the connection chamber 3c. On the other hand, on the side close to the insertion port 3e of the connection chamber 3c, the lower end of the flat contact surface section 9c1 comes into contact with the pin terminal T. A long inter-contact distance L5 can thus be provided and reduce the effect of the pivotal motion of the pin terminal T in the clockwise direction R2, whereby even slight pivotal motion can be reliably handled. The pin terminal T tries to pivot around the point where the pin terminal T is in contact with the lower end of the non-displacing contact surface section 9c1, but the pivotal motion is not allowed not only by the second contact piece section 9d but the first contact piece section 9b, which is located between the pin terminal T and the second contact piece section 9d. The two contact piece sections, the first contact piece section 9b and the second contact piece section 9d, can thus more reliably suppress the pivotal motion of the pin terminal T in the clockwise direction R2, whereby occurrence of plated film separation due to the minute sliding contact and other undesirably phenomena can be avoided.

In the multi-contact connector 1, the long inter-contact distances L4 and L5 reliably suppress the pivotal motion of the pin terminal T at the first contact section 9b2 and the second contact section 9d2 (contact protrusion 9d3), which each serves as the center of the pivotal motion, but a short inter-contact distance L6 between the first contact section 9b2 and the second contact section 9d2 (contact protrusion 9d3) is achieved, as shown in FIG. 10, whereby an increase in the size of the contact section 9 is suppressed. That is, the contact surface section 9c1 is formed as a flat surface extending from a point close to the insertion port 3e to a point beyond the first contact section 9b2 and the second contact section 9d2 (contact protrusion 9d3) in the insertion direction of the pin terminals T (direction Z). The position where the pin terminal T comes into contact with the contact surface section 9c1 on the far side in the insertion direction when the pin terminal T pivots in the counterclockwise direction R1 can therefore be a farther position in the connection chamber 3c beyond the second contact section 9d2 (contact protrusion 9d3). Similarly, the position where the pin terminal T comes into contact with the contact surface section 9c1 on the side close to the insertion port 3e when the pin terminal T pivots in the clockwise direction R2 can be a position shifted toward the insertion port 3e beyond the first contact section 9b2. The pivotal motion of the pin terminal T can therefore be more reliably suppressed with a short inter-contact distance L6 and hence no increase in the size of the contact section 9.

The contact receiving section 9c has the fixing sections 9c2, which are formed at a front end portion located in a position close to the insertion port 3e in the connection chamber 3c and fixed to the movable housing 3. The contact receiving section 9c can therefore be reliably so fixed as not to protrude into the connection chamber 3c, whereby the pin terminal T comes into contact with the front end portion of the contact receiving section 9c to be avoided buckling of the contact receiving section 9c.

The first contact piece section 9b and the second contact piece section 9d are formed as spring pieces displaceable independently of each other. The first contact piece section 9b and the second contact piece section 9d can therefore each come into contact with the pin terminal T independently of the other without affecting the contact pressure, the contact position, and other contact states of the other with respect to the pin terminal T.

The second contact piece section 9d is configured as a part linked to the contact receiving section 9c. More specifically, the base end of the second elastic arm 9d1 is so formed as to be linked to the contact receiving section 9c, whereby an increase in the size of the contact section 9 is suppressed. That is, in the case of forming the second contact piece section 9d in such a way that it extends from the fixed base section 9a in parallel to the first contact piece section 9b in the same direction in which the first contact piece section 9b extends, the first contact section 9b2 and the second contact section 9d2 need to be positionally shifted from each other in the insertion direction of the pin terminals T (direction Z) to avoid interference between the first contact section 9b2 and the second contact section 9d2. In this case, the size of the contact section 9 undesirably increases in the insertion direction (direction Z). On the other hand, configuring the second contact piece section 9d as a part linked to the contact receiving section 9c allows reduction in the size of the second contact piece section 9d because the direction in which the first elastic arm 9b1 extends and direction in which the second elastic arm 9d1 extends does not coincide with each other but intersect each other, whereby the size of the contact section 9, which has a terminal structure having the two contact piece sections 9b and 9d, can be reduced.

The second elastic arm 9d1 is so formed as to link the plate edges 9a1 and 9c3 to each other, which are located on the same side with the linkage section 9f, which links the fixed base section 9a to the contact receiving section 9c, whereby the second elastic arm 9d1 and the linkage section 9f are disposed side by side on one side of the contact section 9. An increase in the size of the contact section 9 in the width direction (direction X) can therefore be suppressed, whereby the size of the multi-contact connector 1 can be reduced.

The first contact section 9b2 protrudes beyond the contact protrusion 9d3 of the second contact section 9d2 toward the contact receiving section 9c. Therefore, when the pin terminal T is inserted, the pressing contact provided by the first contact section 9b2 presses the pin terminal T against the contact surface section 9c1 to achieve an appropriate insertion attitude of the pin terminal T along the flat surface of the contact surface section 9c1. In this state, the contact protrusion 9d3 can achieve pressing contact with the pin terminal T, whereby contact that causes buckling of the second contact section 9d2 can be avoided.

The first contact section 9b2 is formed in a convexly bent shape. The space above an inclining piece of the first contact section 9b2 or the inclining piece on the far side in the insertion direction therefore forms a dead space. In the multi-contact connector 1, however, since the second contact section 9d2 is disposed in the space, the second contact section 9d2 does not protrude beyond the space between the first contact section 9b2 and the linkage section 9f and out of the contact section 9, whereby the size of the contact section 9 can be reduced, and the multi-contact connector 1 can also be formed as to be compact.

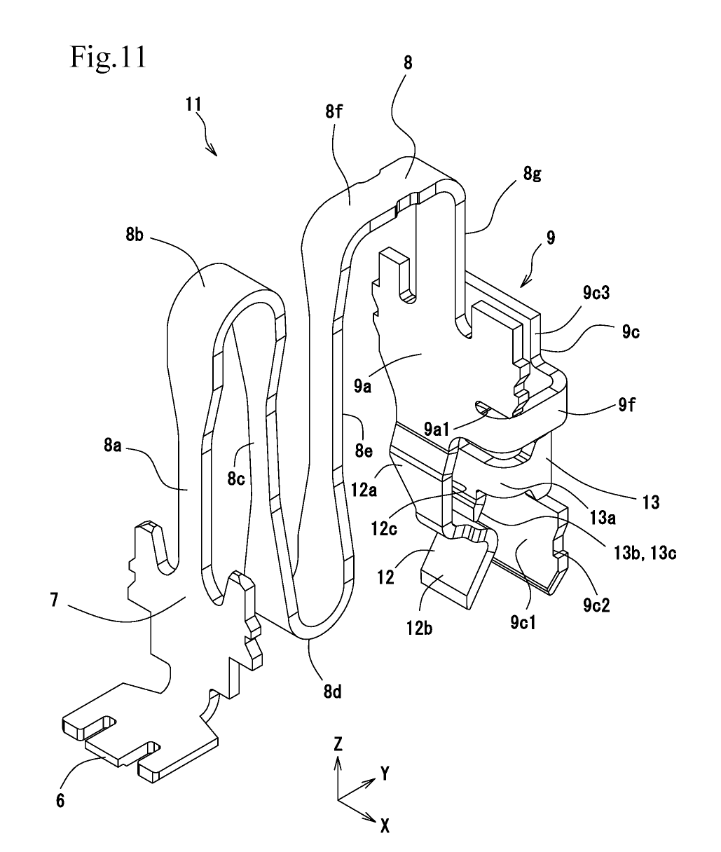

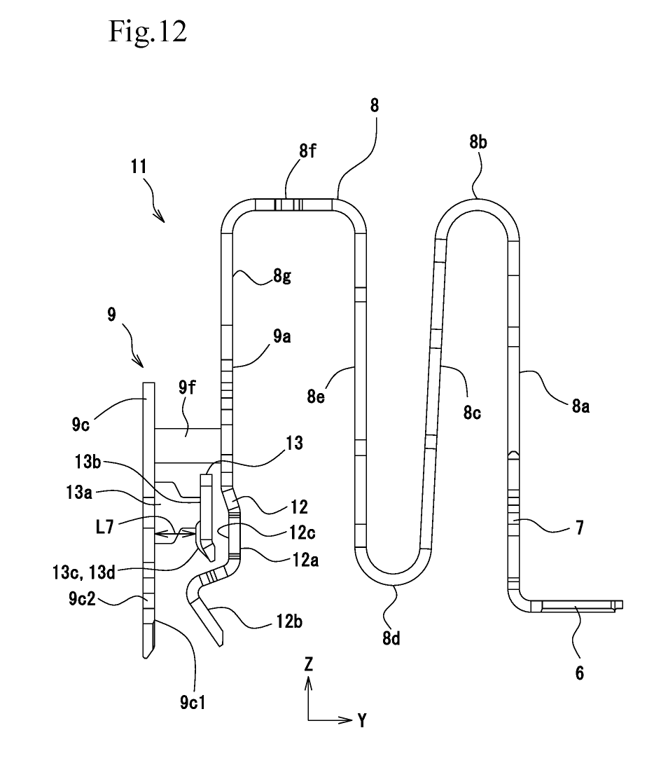

### Second Embodiment [FIGS. 11 to 12]

A multi-contact connector according to a second embodiment differs from the multi-contact connector 1 according to the first embodiment in terms of a first contact piece section 12 and a second contact piece section 13 of each of terminals 11, and the two multi-contacts are the same in terms of the other configurations and advantageous effects based thereon. Only the differences will therefore be described, and the points common to those in the first embodiment will not be redundantly described.

The first contact piece section 12 has a first elastic arm 12a and a first contact section 12b, which is the same as the first contact section 9b2 in the first embodiment. Out of the two components that form the first contact piece section 12, the first elastic arm 12a has a clearance recess section 12c, which is formed in the middle of the first elastic arm 12a and bends so as to protrude toward the side opposite the second contact piece section 13.

The second contact piece section 13 in the present embodiment has a second elastic arm 13a and a second contact section 13b. Out of the two components that form the second contact piece section 13, the second contact section 13b has a guiding inclining surface 13c, which guides the insertion of the pin terminal T, at a front end portion of the second contact section 13b. The second contact section 13b further has a contact protrusion 13d which seamlessly protrudes in the form of a bead from the guiding inclining surface 13c, and the contact protrusion 13d achieves pressing contact with the pin terminal T.

The multi-contact connector including the thus configured terminals 11 in the second embodiment can provide the following advantageous effects in addition to the advantageous effects provided by the multi-contact connector 1 according to the first embodiment.

First, the first elastic arm 12a has the clearance recess section 12c. Therefore, when the second contact section 13b achieves pressing contact with the pin terminal T and is therefore displaced toward the first elastic arm 12a, the second contact section 13b merely enters the clearance recess section 12c but does not come into contact with the first elastic arm 12a. The second contact section 13b can therefore achieve electrically continuous contact with the pin terminal T at predetermined contact pressure. In a case where no clearance recess section 12c is formed, the second contact section 13b needs to be further separate from the first contact piece section 12 so that the displaced second contact section 13b does not come into contact with the first elastic arm 12a. Specifically, the linkage section 9f shown in FIG. 12 needs to be further extended leftward in FIG. 12. In this case, the size of the terminals 11 and the size of the multi-contact connector that includes the terminals 11 undesirably increase in the frontward/rearward direction Y. However, since the clearance recess section 12c can avoid the contact between the second contact section 13b and the first elastic arm 12a, the first elastic arm 12a and the second contact section 13b can be so disposed as to approach each other, whereby the terminals 11 and the multi-contact connector can be so formed as to be compact.

The guiding inclining surface 13c, which guides the insertion of the pin terminal T, is formed at the front end portion of the second contact section 13b. Therefore, even when the pin terminal T is obliquely inserted and is therefore likely to go through the space between the front end of the second contact section 13b and the first contact section 12b, the pin terminal T abuts against the guiding inclining surface 13c and is therefore not allowed to enter the space.

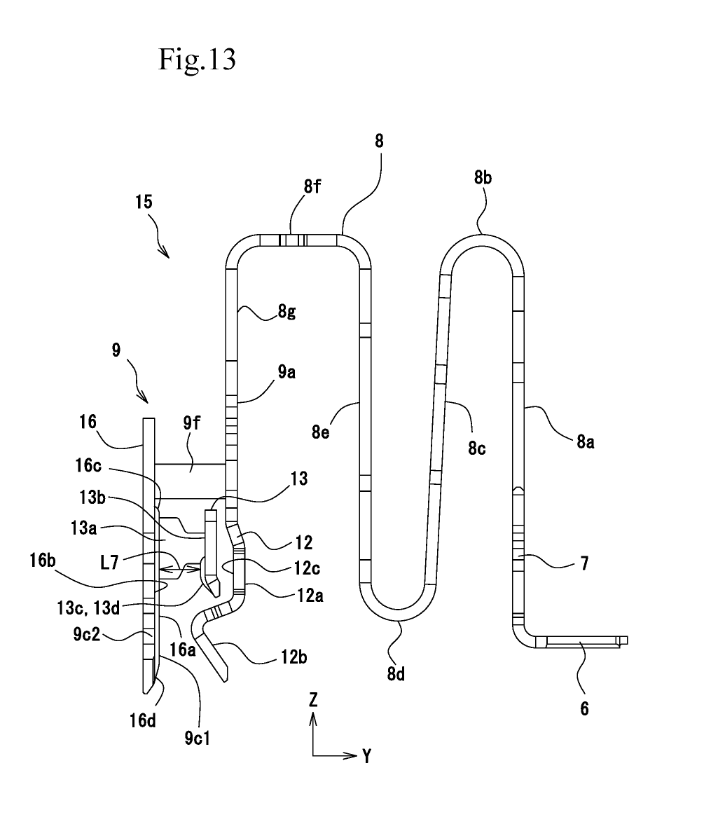

### Third Embodiment [FIGS. 13 to 15A and 15B]

A multi-contact connector according to a third embodiment differs from the multi-contact according to the second embodiment in terms of a contact receiving section 16 of each of terminals 15, and the two multi-contact connectors are the same in terms of the other configurations and advantageous effects based thereon. Only the differences will therefore be described.

A contact surface section 16a, which protrudes toward the first contact section 12b and the second contact section 13b, is formed in a central portion of the contact receiving section 16 of each of the terminals 15. The contact surface section 16a is so formed as to be wider than the pin terminal T but narrower than the contact receiving section 16 in the width direction (direction X), and the contact surface section 16a is further so formed as to extend in the length direction (direction Z) from the front end of the contact receiving section 16 to a position between the second elastic arm 13a and the linkage section 9f. When the contact surface section 16a is taken as a “protruding portion” of the contact receiving section 16, the area around the contact surface section 16a is a flat general surface section 16b, which forms a “non-protruding portion” of the contact receiving section 16. The contact surface section 16a is formed of a bead-shaped “protrusion,” and an opposite surface of the contact surface section 16a that comes into contact with the pin terminal T is a recess. The insertion gap L7, into which the pin terminal T is inserted, between the contact surface section 16a and the contact protrusion 13d of the second contact section 13b is set to be equal to the insertion gap L7, into which the pin terminal T is inserted, between the contact surface section 9c1 and the second contact section 13b in the second embodiment, so that the gap between the contact receiving section and the second contact piece section is greater in the third embodiment than in the second embodiment in the frontward/rearward direction (direction Y) by the length over which the contact surface section 16a protrudes.

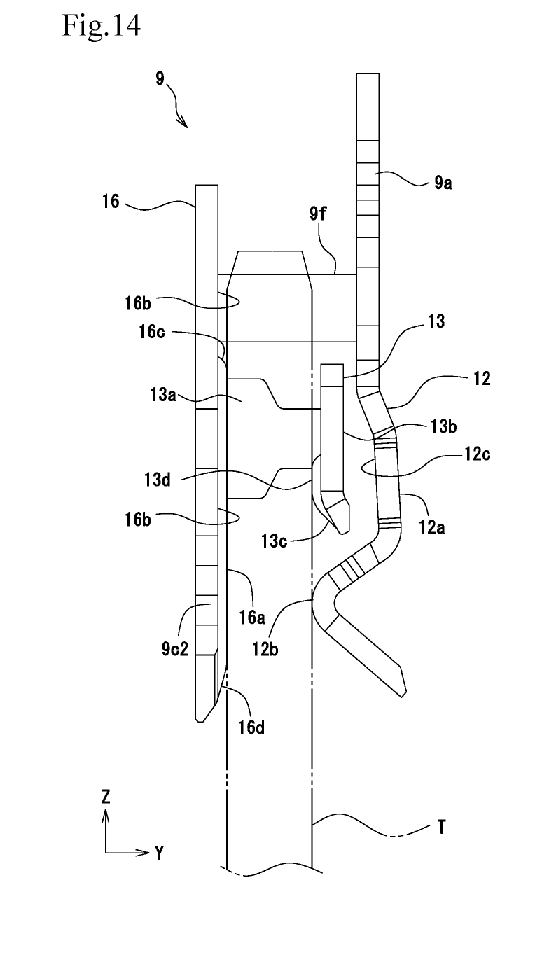

FIG. 14 shows the state in which the pin terminal T is in contact with the contact surface section 16a. Steps 16c and 16d are formed at one end and the other end of the contact surface section 16a, respectively, in the insertion direction of the pin terminals T. Therefore, in the fitting connection state in which the pin terminal T is fitted and connected to the contact section 9, the pin terminal T is not in contact with but separate from the general surface section 16b, which is lower than the contact surface section 16a, and the pin terminal T is in contact only with the contact surface section 16a.

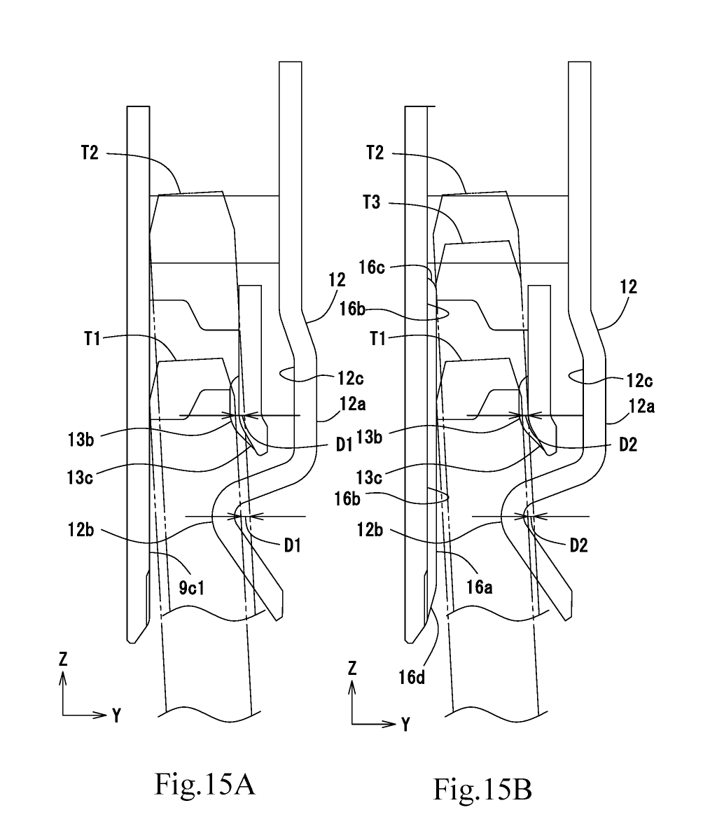

The thus configured contact surface section 16a provides the following advantage over the second embodiment: In the second embodiment, the contact surface section 9c1 is a flat surface, and when the insertion length of the pin terminal T varies and the pin terminal T is obliquely inserted, the amount of displacement of the first contact section 12b and the amount of displacement of the second contact section 13b differs from each other by a difference D1, as shown in FIG. 15A. That is, the amounts of displacement of the first contact section 12b and the second contact section 13b produced by a pin terminal Tl, which is inserted by a smaller length, are smaller than the amounts of displacement produced by a pin terminal T2, which is inserted by a greater length, and the greater the insertion length is, the greater the difference D1 in the amount of displacement is. The difference D1 in the amount of displacement is reflected in the difference in the contact pressure acting on the pin terminal T, and the greater the difference D1 in the amount of displacement is, the higher the difference in the contact pressure is. Therefore, in the second embodiment, the contact pressure at each of the first contact section 12b and the second contact section 13b undesirably depends on the insertion length of the pin terminal T, so that the contact pressure cannot be controlled by the terminal 15 itself. Therefore, in a case where pressing contact provided at specific contact pressure needs to be performed on the pin terminal T, fitting connection based on a precise insertion length of the pin terminal T is required.

In contrast, in the case where the contact surface section 16a, which protrudes from the general surface section 16b, is provided, no management of the fitting connection achieved by a precise insertion length of the pin terminal T is required. That is, the pin terminal T1 shown in FIG. 15B indicates an insertion position that minimizes the insertion length (effective fitting length) that allows electrically continuous contact with the first contact section 12b and the second contact section 13b. The pin terminal T2 indicates an insertion position that provides an insertion length that allows electrically continuous contact with the first contact section 12b and the second contact section 13b and causes the front end of the pin terminal T2 to be located beyond the upper end of the contact surface section 16a, and this insertion position is a normal contact position. Even when the pin terminal T1 and the pin terminal T2 differ from each other in terms of the insertion length, a difference D2 in the amount of displacement between the first contact section 12b and the second contact section 13b can be reduced as compared with the case shown in FIG. 15A. In particular, a pin terminal T3 indicates an insertion position where the front end of the pin terminal T3 comes into contact with the contact surface section 16a in a position before the step 16c at the upper end of the contact surface section 16a, and the pin terminal T3 and the pin terminal T2, which is so inserted as to be located beyond the step 16c, produce the same amounts of displacement of the first contact section 12b and the second contact section 13b, and the contact pressure is therefore the same. The contact pressure produced by the first contact section 12b and the second contact section 13b can therefore be controlled by the terminal 15 itself irrespective of the insertion length of the pin terminal T.

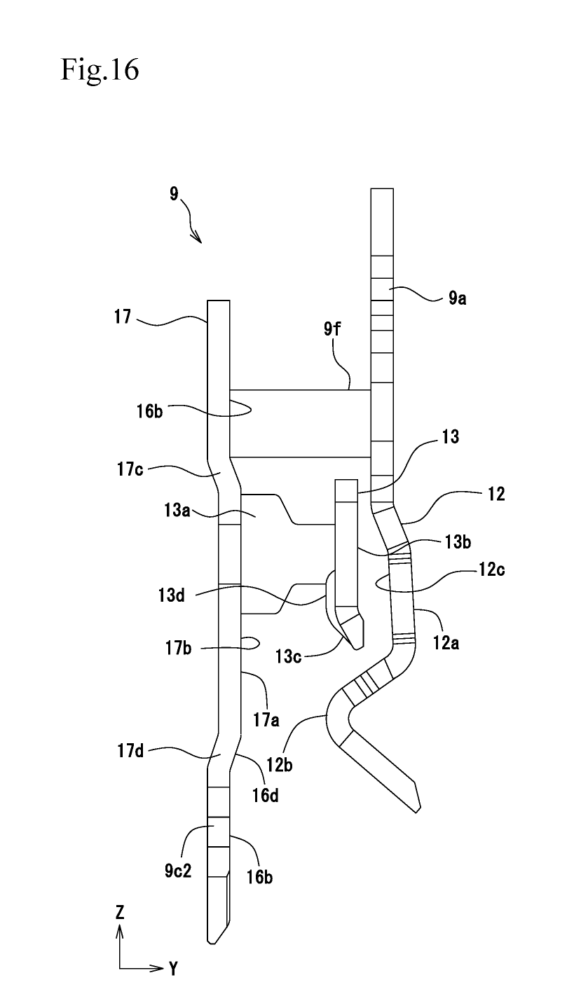

### Variation of Third Embodiment [FIG. 16]

The contact receiving section 16 in the third embodiment described above can be replaced with a contact receiving section 17 in a variation shown in FIG. 16. The contact receiving section 17 has a contact surface section 17a, which protrudes toward the first contact section 12b and the second contact section 13b. The contact surface section 17a is formed of a protruding surface section 17b, a first bent section 17c, and a second bent section 17d. The contact surface section 17a, which provides the same advantageous effect provided by the contact surface section 16a in the third embodiment, can be provided by bending an electrically conductive plate that is the raw material of the contact receiving section 17. That is, when the pin terminal T is inserted to a point beyond the first bent section 17c, the contact pressure produced by the first contact section 12b and the second contact section 13b can be controlled to be a fixed value by the terminal 15 itself irrespective of the insertion length of the pin terminal T.

To employ the contact surface section 17a, the first bent section 17c needs to be formed in a position between the second elastic arm 13a and the linkage section 9f, and the second bent section 17d needs to be formed in a position closer to the front end of the contact receiving section 17 than the first contact section 12b. Further, since the fixing sections 9c2 need to be provided in a position closer to the front end of the contact receiving section 17 than the second bent section 17d, the contact receiving section 17 in the variation is undesirably longer than the contact receiving section 16 in the third embodiment. Conversely, the contact receiving section 16 having the bead-shaped contact surface section 16a can be so formed to be shorter than the contact receiving section 17 in the variation, in which the contact surface section 17a is caused to protrude by bending, and is therefore advantageous in that the size of the terminals 15 can be reduced and the size of the multi-contact connector that includes the terminals 15 can be reduced.

### Other Variations

In the embodiments described above, the contact receiving sections 9c, 16, and 17 are so formed by way of example as to extend from the portion linked to the linkage section 9f to the position facing both the first contact sections 9b2 and 12b and the second contact sections 9d2 and 13b. Instead, for example, the contact receiving sections 9c, 16, and 17 can be so formed as to extend from the portion linked to the linkage section 9f to the position facing only the second contact sections 9d2 and 13b. The contact receiving sections 9c, 16, and 17 can therefore be shortened, whereby the size of the terminals 4 and the size of the entire multi-contact connector 1 including the terminals 4 can be reduced in the height direction (direction Z). Still instead, the contact receiving sections 9c, 16, and 17, to further shorten them, can be configured to extend from the portion linked to the linkage section 9f to a portion linked to the second elastic arms 9d1 and 13a but face none of the first contact sections 9b2, 12b and the second contact sections 9d2, 13b. The sizes of the terminals 4 and the multi-contact connector 1 can therefore be further reduced in the direction Z.

What is claimed is:

1. A multi-contact connector comprising: terminals each including
a first contact piece section having a first contact section that achieves pressing contact with a connection target object in a first direction and a first elastic arm that extends in a direction that intersects the first direction and displaceably supports the first contact section, and
a second contact piece section having a second contact section that achieves pressing contact with the connection target object in the first direction and a second elastic arm that displaceably supports the second contact section,
wherein the second elastic arm extends in the first direction toward the first elastic arm and has a front end portion facing the first elastic arm and is formed as a spring piece linked to the second contact section.

2. The multi-contact connector according to claim 1, wherein the second contact section faces the first elastic arm.

3. The multi-contact connector according to claim 1, wherein the terminals each have a support piece to which the second elastic arm is linked.

4. The multi-contact connector according to claim 3, wherein the support piece is so formed as to extend from a portion linked to the second elastic arm to a position facing the second contact section.

5. The multi-contact connector according to claim 3, wherein the support piece is so formed as to extend from a portion linked to the second elastic arm to a position facing the first contact section and the second contact section.

6. The multi-contact connector according to claim 3, wherein the second elastic arm is so shaped as to link opposing plate edges of the second contact section and the support piece.

7. The multi-contact connector according to claim 3, wherein the terminals each have a fixed base section that supports the first contact piece section in a form of a cantilever and a linkage section that extends in the first direction and links the fixed base section to the support piece.

8. The multi-contact connector according to claim 1, wherein the first contact piece section has a clearance recess section that avoids contact with the second contact section displaced toward the first contact piece section when the second contact section receives the pressing contact achieved by the connection target object.
